(19) United States
(12) Patent Application Publication
(10) Pub. No.: US 2026/0196016 A1
(43) Pub. Date: Jul. 9, 2026

(54) GASKET PART SELECTION VIA IMAGE PROCESSING

(71) Applicant: PT Intermediate Holdings IV, LLC, Addison, IL (US)

(72) Inventors: Spiro Papadopoulos, Wilmette, IL (US); James J. Davis, Rockford, IL (US)

(21) Appl. No.: 19/439,984

(22) Filed: Jan. 5, 2026

Related U.S. Application Data
(60) Provisional application No. 63/742,150, filed on Jan. 6, 2025.

(51) Int. Cl. G06V 10/75; G06V 10/74; G06V 10/774; G06V 10/82

(52) U.S. Cl. CPC G06V 10/754; G06V 10/751; G06V 10/761; G06V 10/774; G06V 10/82; G06T 2200/24

(57) ABSTRACT

Methods, systems, and apparatuses for performing image processing. One apparatus includes at least one electronic processor and at least one memory storing instructions executable by the at least one electronic processor. The at least one electronic processor is configured, through execution of the instructions, to receive a cross-section image of a gasket, the gasket having one or more defects, generate one or more modified representations of the gasket represented in the cross-section image, the one or more modified representations of the gasket representing the gasket without the one or more defects, and identify, based on the one or more modified representations of the gasket, a replacement gasket.

### RELATED APPLICATIONS

This application claims priority to U.S. Provisional Application No. 63/742,150, filed Jan. 6, 2025, the entire content of which is incorporated by reference herein.

### FIELD

Examples described herein generally relate to image processing and, in particular, image matching or classification.

### SUMMARY

Gasket replacement and identification has long been a challenge in various industries, particularly in appliance maintenance and repair. Gaskets may be used for sealing and insulation, and thus often require replacement due to wear and tear over time. Traditional methods of gasket identification have relied heavily on manual inspection and comparison, often requiring technicians to carry physical samples for reference.

Current approaches to gasket identification and replacement face several limitations. Manual inspection methods are time-consuming and prone to human error, especially when dealing with subtle defects or deformations. The comparison process remains subjective and may not account for all variations in wear patterns.

Examples described herein address these issues with existing gasket inspection using image recognition technologies and, in particular, address unique challenges presented by gaskets relating to defects, which may include deformations that occur over time due to compression, stretching, or material degradation. Accordingly, examples described herein provide an improvement in image recognition technologies to address specific issues associated with gaskets.

In particular, examples described herein provide a computer-implemented method for gasket part selection via image matching. Gasket part selection is the process of identifying and choosing a replacement gasket that matches the specifications and requirements of a gasket in need of replacement. The gasket in need of replacement may have defects such as deformation, compression, stretching, or cracking. These defects may manifest as changes in the gasket's shape, size, or structure. Image matching is a technological approach that compares visual features of an input image against a database of images to find the closet match. Image matching may utilize image processing techniques and machine learning models to automate the process and improve the accuracy.

Examples of the present disclosure provide systems, methods, and apparatuses for identifying gaskets from images that address limitations with existing gasket identification methods and existing image recognition technology. In some examples, the systems, methods, and apparatuses provided herein utilize cross-sectional imaging to reveal internal structures and defects that are not visible from external inspection. This approach provides a more comprehensive view of the gasket's condition, enabling more accurate matching and replacement recommendations.

In some examples, the system incorporates image matching algorithms specifically tailored to handle gasket deformations. These algorithms may modify the feature representations of the cross-section image based a deformation compensation to obtain a compensated or modified feature representation and perform the image matching based on the modified feature presentation. In some examples, the system utilizes user-provided contextual information, such as appliance manufacturer and size, to increase the accuracy of the image matching.

For example, aspects described herein provide methods, systems, and apparatuses for performing image processing. One apparatus includes at least one electronic processor and at least one memory storing instructions executable by the at least one electronic processor. The at least one electronic processor configured, through execution of the instructions, to receive a cross-section image of a gasket, the gasket having one or more defects, generate one or more modified representations of the gasket represented in the cross-section image, the one or more modified representations of the gasket representing the gasket without the one or more defects, and identify, based on the one or more modified representations of the gasket, a replacement gasket.

A computer-implemented method provided herein includes receiving a cross-section image of a gasket, the gasket having one or more defects, generating, a feature representation of the cross-section image of the gasket using a machine learning model, and identifying, using the machine learning model, a replacement gasket from a dataset including gasket profiles and a deformation compensation.

A computer-implemented method for training a machine learning model provided here includes receiving a training dataset, the training dataset including cross-section image of a gasket having one or more defects, and a ground truth cross-section image of the gasket without defects, generating, using the machine learning model, a modified feature representation based on the cross-section image of the gasket and a deformation compensation, generating, using the machine learning model, a ground-truth feature representation based on the ground-truth cross-section image of the gasket from the training dataset, calculating a loss based on difference between the modified feature representation and the ground-truth feature representation, and updating parameters of the machine learning model based on the loss.

### BRIEF DESCRIPTION OF THE DRAWINGS

FIG. 1 illustrates an image processing system for processing gasket images according to some examples.

FIGS. 2-3 illustrate examples of cross-section images of gaskets according to some examples.

FIG. 4 illustrates an image matching processing performed via the image processing system of FIG. 1 according to some examples.

FIG. 5 illustrates an image processing apparatus included in the image processing system of FIG. 1 according to some examples.

FIG. 6 illustrates a computer-implemented method for performing image processing implemented via the image processing system of FIG. 1 according to some examples.

FIG. 7 illustrates a computer-implemented method for training a machine learning model used in the image processing system of FIG. 1 according to some examples.

### DETAILED DESCRIPTION

One or more example implementations are described and illustrated in the following description and accompanying drawings. These example implementations are not limited to the specific details provided herein and may be modified in various ways. Furthermore, other implementations may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some examples described herein may include one or more electronic processors configured to perform the described functionality by executing instructions stored in non-transitory, computer-readable medium. Similarly, examples described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

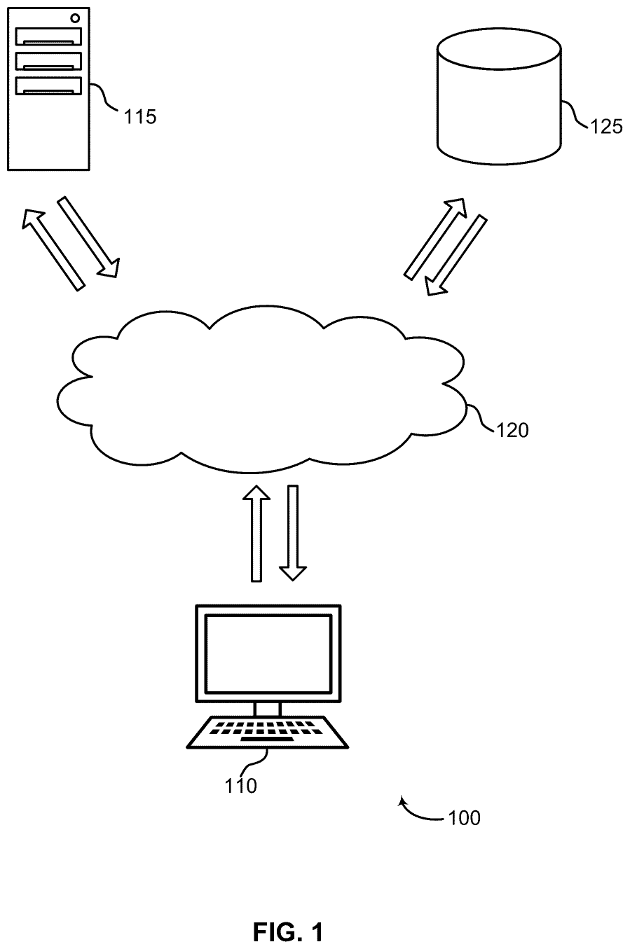

FIG. 1 illustrates an image processing system 100 according to some examples of the present disclosure. The image processing system 100 includes an image capture device 110, an image processing apparatus 115, a communication network 120, and a database 125.

As noted above, gaskets are an important aspect for proper performance of various devices (e.g., consumer appliances, such as, for examples, refrigerators, freezers, dishwashers, ovens, washing machines, air conditioners and similar appliances that use a sealed compartment for temperature control or similar enclosure needs). As also noted above, replacing such a gasket requires inspection and identification of a proper replacement component. However, such inspection and identification of gaskets has unique challenges. The image processing system 100 addresses these challenges by receiving an image of a gasket and performing image matching to identify the appropriate replacement component. The image processing system 100 may also provide instructions for obtaining such an image and may receive additional input used to identify a replacement component for a particular gasket. As described herein, the image processing system 100 may provide a network-based service for such identification, such as a web-based service that may be accessible via a browser application or dedicated software application installed on the image capture device 110, which may be a smart phone or tablet.

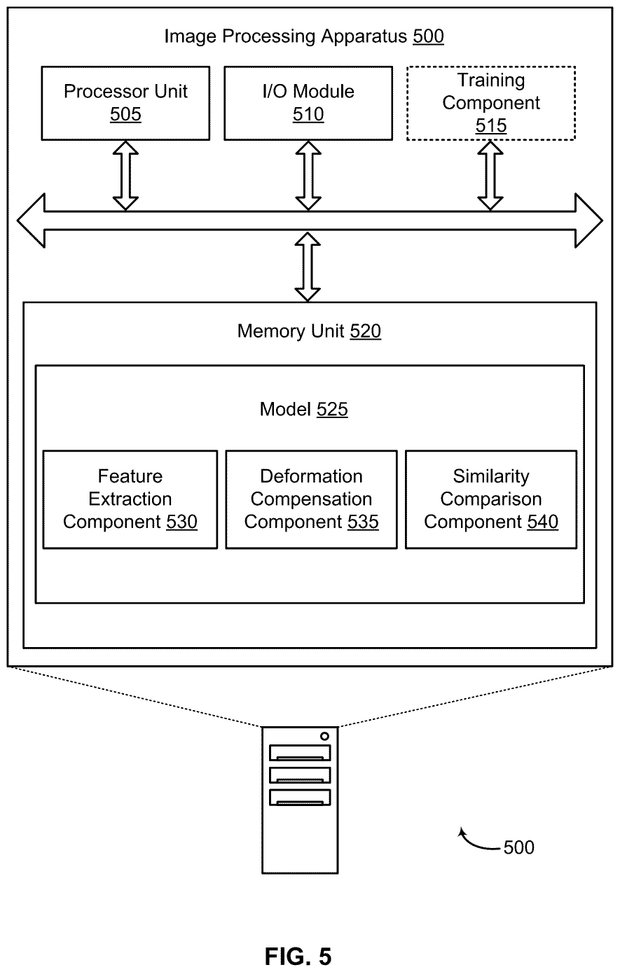

As described in more detail with respect to FIG. 5, the image processing apparatus 115 may include an electronic processor, a memory unit, and an input/output module. The image processing apparatus 115 can communicate with the image capture device 110 via the communication network 120. The image processing apparatus 115 may also communicate with the database 125 via the communication network 120 or via a dedicated communication channel. However, in some configurations, the database 125 may be included in the image processing apparatus. Although the system 100 is illustrated as including one image capture device 110, the system 100 may include any number of image capture devices 110. Also, in some implementations, functionality described herein as being performed via the image processing apparatus 115 may be distributed over multiple devices, such as, for example, as part of a cloud service or other distributed computing environment. Similarly, in some implementations, the system 100 may store and access data in multiple databases included in or separate from the image processing apparatus 115.

In some examples, the image processing apparatus 115 is implemented on a server. A server provides one or more computer-implemented functions to devices connected to the server via one or more communication networks. The server may use various protocols to exchange data with other devices, such as, for example, the hypertext transfer protocol (HTTP), the simple mail transfer protocol (SMTP), the file transfer protocol (FTP), the simple network management protocol (SNMP), or the like. In some cases, the server is configured to send and receive markup language formatted files (e.g., HTML files), which may be used to display web pages at a connected device via a browser application stored on the device.

The communication network 120 may be wired or implemented wirelessly using any suitable protocol. For example, the communication networks 120 may be implemented using a wide area network (for example, the Internet), a local area network (for example, a Wi-Fi network), and combinations or derivatives thereof. It should be understood that the components of the system 100 may communicate over the communication network 120 via various intermediary components (e.g., firewalls, switches, routers, etc.), which are not illustrated in FIG. 1 for sake of brevity. Also, it should be understood that, in some examples, the image processing apparatus 115 may communicate with the image capture device 110 directly (e.g., over one or more dedicated wired or wireless connections) or the functionality described herein as being performed via the image processing apparatus 115 may be implemented locally on the image capture device 110.

The database 125 includes non-transitory computer-readable storage medium storing data used by the system 100 (e.g., the image processing apparatus 115). As descried herein, the database 125 may store reference images of gaskets, which may be used to identify a replacement gasket option via one or more image matching or comparison techniques. Alternatively or in addition, the database 125 may store training data used to develop a model for matching or classifying a captured image of a gasket (i.e., model input) with a replacement gasket (e.g., model output), which may be specified as a model number. It should be understood that, in some examples, the database 125 stores data used by and/or generated within the image processing system 100 and, thus, may provide data storage functionality (without or with standard database functionality).

The image capture device 110 may be a personal computer, a laptop computer, a mobile communication device (e.g., a smart phone), a tablet computer, a smart wearable device, a desktop computer, or any other suitable processing apparatus configured to communicate with the image processing apparatus 115. The image capture device 110 includes one or more input devices, output devices, or a combination thereof for receiving user input and providing output to a user. For example, the image capture device 110 may include an audio device, such as a speaker system, a display device such as a display screen, a touchscreen, or the like, a keyboard, one or more buttons, and/or a cursor control device, or a combination thereof. In particular, the image capture device 110 may include a display device for providing graphical user interfaces (GUIs) as described herein. For example, as described herein, such GUIs may provide instructions for capturing an image of a gasket needing replacement, may prompt a user for additional information regarding the gasket, and may provide replacement options for the gasket. In some examples, such GUIs may be represented in code that is sent to the image capture device 110 by the image processing apparatus 115 and rendered locally by an application executed on the image capture device 110 (e.g., a browser application, a dedicated application, or the like).

For example, in some examples, the image capture device 110 stores a gasket matching application. The gasket matching application may be a dedicated application for performing the functionality described herein or may be a browser application for accessing a web-based matching service provided via the image processing apparatus 115. When the application is executed by an electronic processor of the image capture device 110, the application provides a prompt (via a GUI) with instructions (textual, graphical, audible, or a combination thereof) for capturing an image (a still image or a series of images or video) of the gasket via a camera (an image sensor) of the image capture device 110. In some examples, the image is a cross-section of the gasket, and the application may provide instructions (via a provided GUI) for how to access the gasket (e.g., remove the gasket from the appliance) and cut the gasket to access a cross-sectional surface of the gasket. Similarly, the application may provide instructions (via a provided GUI) regarding how the cross-sectional surface of the gasket should be framed or orientated in the captured image. In some examples, the application may be stored on a computing device separate from the camera used to capture the image, such that the image capture device 110 may communicate with the camera (e.g., a digital camera, a web camera, or the like) to obtain the captured image of the gasket.

The captured image is transmitted (via the communication network 120) from an input/output interface of the image capture device 110 to an input/output interface of the image processing apparatus 115. In this example, in response to receiving the image, the image processing apparatus 115 (i.e., an electronic processor of the image processing apparatus 115 executing one or more software applications or modules) may perform one or more pre-processing checks, which may ensure that the cross-sectional surface of the gasket can be identified in the image (e.g., a required width of the gasket has been captured in the image, the image has a particular resolution, or other conditions are satisfied). The image processing apparatus 115 may perform various image processing techniques to perform such pre-processing checks, such as edge detection techniques, image segmentation, color correction, and the like. In response to the image failing one or more of the pre-processing checks, the image processing apparatus 115 may transmit a notification to the image capture device 110 regarding the failure, which the application on the image capture device 110 may use to provide the same or different prompts and/or instructions to capture and transmit a new image. In some examples, one or more of the pre-processing checks may be performed via the gasket matching application (i.e., at the image capture device 110) before the image is transmitted to the image processing apparatus 115. In addition to or as an alternative to the pre-processing checks, the image processing apparatus 115 and/or the image capture device 110 may modify the image to prepare the image for further processing. Such modification may include, for example, cropping the image, applying one or more masks to the image, or the like.

In response to the captured image passing the one or more pre-processing checks, the image processing apparatus 115 processes the received image to identify a potential replacement gasket. For example, the image processing apparatus 115 may compare the image (or one or more portions thereof) to a set of images (e.g., stored in the database 125), also referred to herein as a set of “reference images”), to identify a potential match. In other words, the image processing apparatus 115 compares the received image (e.g., a profile of the gasket in the received image (e.g., shape, size, configuration, or the like)) to a profile of a gasket represented in the set of reference images and, thus, identifies a matching gasket that may be used as a replacement for the gasket.

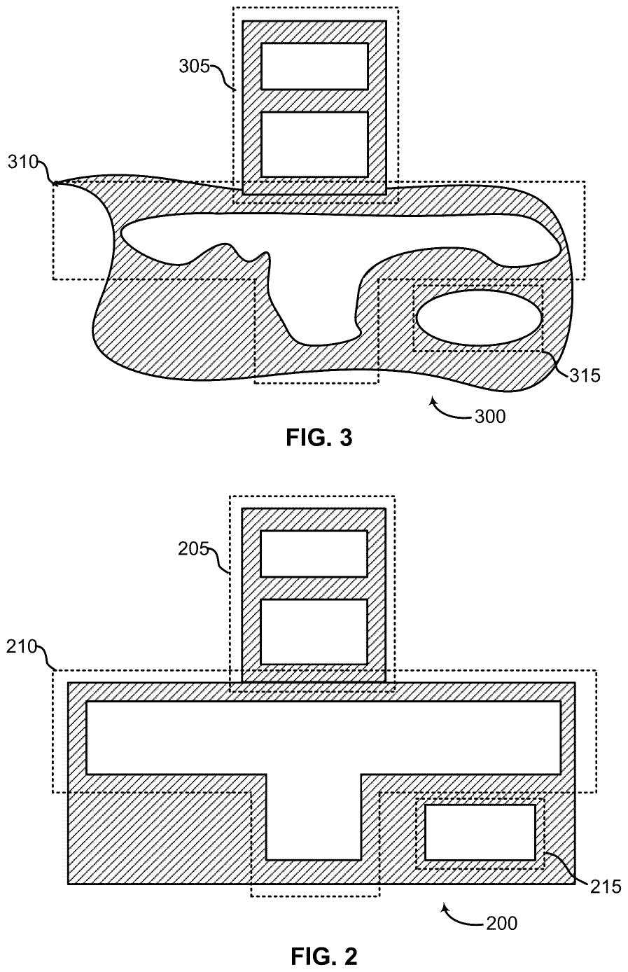

The image processing apparatus 115 may use deformation compensations to facilitate the matching. As noted above, during use, a gasket may obtain defects, such as compression or stretching, rips, tears, deformations, etc. For example, FIG. 2 shows an example of a cross-section image 200 of a gasket without defects (e.g., representing a new or normal condition version of the gasket). The gasket represented in the cross-section image 200 includes a first structure 205, a second structure 210, and a third structure 215. It should be understood that a particular gasket can have various shapes, sizes, and cross-sectional profiles, including having fewer or additional structures. The gasket illustrated in FIG. 2 is provided as one example gasket and the functionality described herein is not limited to this example gasket or gaskets with similar constructions or profiles.

FIG. 3 shows an example of a cross-section image 300 of the same gasket represented in the image 200, wherein the gasket has defects. As illustrated in FIG. 3, the gasket includes a first structure 305, a second structure 310, and a third structure 315. While the first structure 305 in the image 300 may generally match the size, shape, and configuration of the first structure 205 represented in the image 200, the second structure 310 and the third structure 315 represented in the image 300 includes defects as the size, shape, and configuration differs from the second and third structures 210 and 215 represented in the image 200. For example, the second structure 310 is compressed, stretched, and deformed as compared to the structure 210, which demonstrate a bulging area or a thinned-out portion that may no longer provides an effective seal. The third structure 315 similarly shows a defect in the form of a compression of the third structure 215. Such defects may be caused by wear and tear on the gasket during repeated use (e.g., opening and closing of a door), temperature exposures, chemical exposures, cuts or rips, or the like.

Accordingly, the cross-sectional view of a gasket represented in a captured image may not match the same view of a new or normal version of the same gasket (i.e., same model of gasket) and, thus, it may be difficult to perform a direct image or profile match and identify a replacement option. To solve these and other technical problems, the image processing system 100 described herein accounts for such defects to improve the accuracy of image comparisons and replacement option identification.

For example, in some examples, the image processing apparatus 115 generates one or more derivative images by stretching or compressing the captured image in one or more ways, where the derivative images represent potential non-deformed states of the gasket. The derivative images are then compared against a set of stored reference images representing non-deformed states of gaskets to find a match. In some examples, the image processing apparatus 115 may further utilize additional information, such as the appliance's age, type, or brand, to generate the derivative images. The additional information may control or guide the generation of the one or more derivative images. For example, the older the appliance, the more the captured image may be modified (e.g., compressed, stressed, altered, etc.). Similarly, particular types, brands, or models may have known deformation profiles, and, thus, a captured image associated with such a brand or model may be modified in a particular way. In some examples, the image processing apparatus 115 may access stored rules that define particular types of image modification, which may be selected based on the additional information provided for an imaged gasket. If no such additional information is provided, a set of default rules may be applied to generate the derivative images. Similarly, in some examples, additional information may be used to filter and/or rank the set of images (e.g., accessed from the database 125) to compare to the derivative images. For example, if the appliance related to the gasket represented in the captured image is a refrigerator, reference images representing gaskets not used with refrigerators may not be compared to the derivative images to improve the efficiency and accuracy of the matching.

Alternatively or additionally, the reference images may include images representing various deformed states. Such images may be virtually altered versions of an image of a new or normal gasket, similar to the alterations described above but in an opposite manner. Accordingly, in this configuration, the received captured image is compared to the altered images included in the reference images to find a match. Any additional information provided for a captured image may similarly be used to filter images used with the comparison and/or filter or rank results, which improves the speed at which one or more matches can be identified and reduces the processing resources used by the system 100.

Also, in some examples, as it may be difficult to generate a set of reference images representing all possible defects, a combination of the above approaches may be used. For example, an inputted image may be modified to account for some defects (e.g., tears, rips, etc.) (and, thus, generate one or more derivative images) and these derivative images may be compared with the references images that may include example deformations of gaskets (in addition to or as an alternative to images of new or normal gaskets).

The image matching performed by the image processing apparatus 115 may include one or more image matching or comparison techniques, such as, for example, pixel comparisons, fuzzy pixel comparisons, histogram comparisons, correlation comparisons, image masks, keypoint detection or feature registration (using, for example, a scale invariant feature transform (SIFT) algorithm), difference imaging, cross-correlation, mutual information, sum of squared intensity differences, ratio image uniformity, or the like. In some examples, the image processing apparatus 115 may be configured to use different image comparison techniques and may select an appropriate technique from available techniques based on, for example, characteristics of the image, any provided additional information, or a combination thereof. Also, in some examples, the image processing apparatus 115 is configured to find a matching gasket using more than one image comparison technique and use the results from each technique to filter or rank matches. In response to identifying a “matching” image from the reference images, metadata (header information, a tag, paired data) associated with the image that identifies a unique identifier of the gasket represented within the image is used to provide a recommended replacement option.

The additional information noted above may be provided as user input. For example, one or more prompts for the additional information may be provided in a GUI presented on the image capture device 110 (e.g., generated via an application on the image capture device 110 or within a GUI provided via the image processing apparatus 115). The additional information may include information identifying an appliance, such as, for example, an appliance type, an appliance manufacturer, an appliance model, appliance age (e.g., represented as a duration of years or a purchase or install date), an appliance size, or the like. The additional information may also include information the gasket, such as, for example, a location of the gasket, a color of the gasket, an estimated condition of the gasket, an approximate age of the gasket, a frequency of use associated with the appliance/gasket, or the like. The additional information can be sent to the image processing apparatus 115 via the communication network 120, wherein the image processing apparatus 115 initiates a comparison process as described above. The image processing apparatus 115 may identify a predetermined number of “top” results (e.g., the top three most likely matches) of likely matches for the gasket captured in the image and transmit the result back through the communication network 120 to image processing apparatus 115.

Regardless of how the replacement options are identified, the provided results may represent one or more replacement options, and the replacement options may be provided in a graphical user interface wherein, for each option, an image of the gasket representing the potential match is provided along with supporting information, such as for example, a corresponding model numbers or compatibility ratings. In this example, one of the replacement options may be selected through the graphical user interface for purchase.

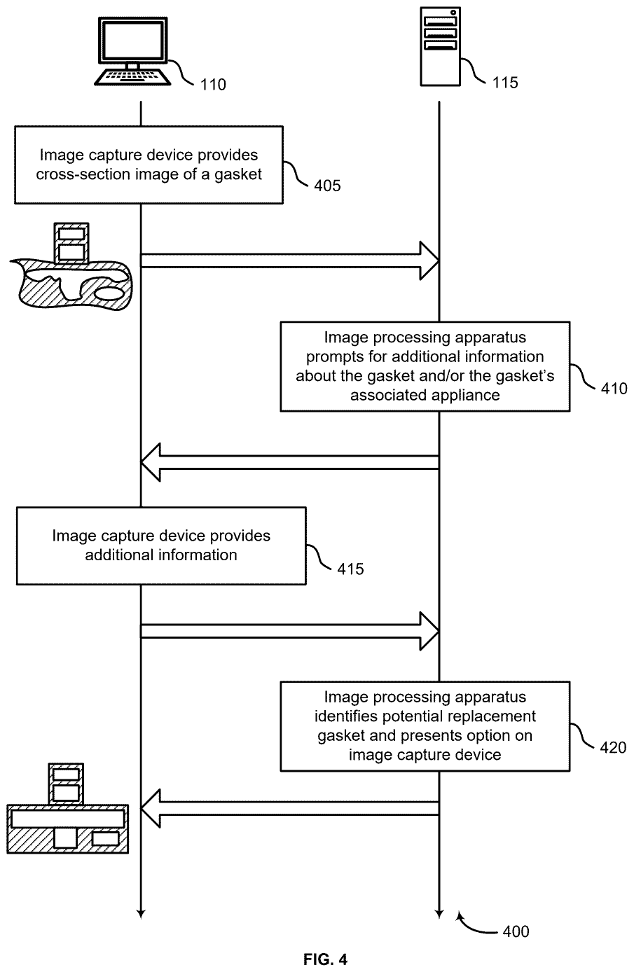

FIG. 4 illustrates an example process 400 between the image capture device 110 and the image processing apparatus 115. At operation 405, the image capture device 110 provides, as input, a cross-section image of a gasket to the image processing apparatus 115. This operation 405 may include capturing an image of the gasket using, for example, a camera of the image capture device 110, accessing an image from a memory of the image capture device 110, or receiving an image from an external device, such as, for example, a digital camera, a webcam, or the like. As noted above, the image captures a current state of the gasket, including any wear, deformation, or damage that may be present and may be a cross-sectional view of the gasket.

At operation 410, in response to receiving the input image, the image processing apparatus 115 prompts the user for additional contextual information, including information about the gasket, the gasket's associated appliance, or a combination thereof. The prompt may be a series of questions, designed to gather specific details that are not discernible from the image alone. The prompt may be provided on a GUI presented on a display screen of the image capture device 110. The GUI may include text input mechanisms, drop-down menus, radio buttons, or the like and may be dynamic such that prompts and/or options presented within the GUI are updated as input is received. For example, the GUI may initially prompt for a type of appliance associated with the gasket and then may customize subsequent prompts based on the type of appliance specified to aid a user in providing/selecting accurate information regarding the gasket.

At operation 415, in response to the prompts, user input is provided via the image capture device 110 back to the image processing apparatus 115. As previously noted, this information may include the appliance type (e.g., refrigerator, dishwasher, oven), the brand name, the model number, years of usage, frequency of usage, or a combination thereof.

At operation 420, based on both the inputted cross-section image and the additional contextual information, the image processing apparatus 115 uses one or more image matching algorithms as described above to analyze the input image, taking into account the additional information provided by the user. The image processing apparatus 115 retrieves and presents one or more matching replacement gasket options (e.g., images and associated ordering information) via one or more GUIs presented on the image capture device 110.

In some examples, the image processing apparatus 115 may also be configured to determine a condition of the gasket represented in the captured image (in addition to or as an alternative to providing a replacement option). For example, in some examples, the image processing apparatus 115 may be configured to determine an amount of deformation of the gasket (e.g., based on the matching image identified or the amount of deformation associated with a derivative image that matched a reference image). The condition represented by this amount of deformation may be associated with a recommendation regarding whether a particular type of gasket should be installed (e.g., one that wears better given heavy use), other maintenance that may need to be performed to prevent such deformation in the future, appliances associated with less deformation in gaskets, etc. The image processing apparatus 115 may apply various rules to equate a level of deformation with a condition as well as recommendations associated with the condition.

Similarly, in some examples, a condition may be based the material of the gasket, such as whether the gasket has faded or changed color, has mold or other substances on it, etc. For example, when a matching image is identified (which may be identified using a version of the inputted image that does not account for specific colors or surface textures of the gasket), the matching image or defined characteristics of the gasket represented in the matching image may be captured with the inputted image to determine whether a color, texture, or the like of the gasket represented in the captured image is “normal” or deviates from what is expected. A deviation may be used to assign a condition and/or provide a recommendation to a user, which may include, for example, a recommendation of a particular type of gasket that may be constructed from a material less susceptible to fade, corrosion, mold, etc.

In addition to or as an alternative to comparing a captured image with stored images of gaskets, the image processing apparatus 115 may use a model to generate a feature representation of the gasket represented within the image and may compare this feature representation to a set of gasket profiles, which may include a feature representation for a gasket, an cross-sectional image of such a gasket (from which a feature representation may be generated), or a combination thereof. Each gasket profile may be associated with a unique gasket identifier, which may be, for example, a model number, a stock-keeping-unit (SKU), or the like. Accordingly, this model can be configured to receive, as input, a captured image of a gasket and output a unique identifier of one or more gaskets that may match the gasket represented in the captured image and, thus, represent replacement options for the gasket.

The model may use one or more feature representations of a gasket represented in an image and, in some examples, may use feature representations for different structures within the gasket. For example, in some examples, the image processing apparatus 115 generates feature representations for the first structure 205, the second structure 210, and the third structure 215. In some examples, the image processing apparatus 115 uses a deformation compensation to virtually restore the feature representations, generating compensated or modified feature representations. Accordingly, rather than modifying a captured image as described above when image matching is performed, feature representations generated for a captured image may be modified and these modified representations may be used to classify the image.

For example, FIG. 5 shows an example of the image processing apparatus 115 (referenced as image processing apparatus 500 in FIG. 5), which may be used with the system 100 described herein. The image processing apparatus 500 includes a processor unit 505, an I/O module 510, an optional training component 515, a memory unit 520, and a model 525. The model 525 may include a feature extraction component 530, a deformation compensation component 535, and a similarity comparison component 540.

The processor unit 505 includes one or more electronic processors. An electronic processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. The processor unit 505 is configured to execute computer-readable instructions stored in the memory unit 520 to perform various functions, including, for example, the functionality described herein with respect to machine learning.

The memory unit 520 includes one or more memory devices. Examples of a memory device include random access memory (RAM), read-only memory (ROM), or a hard disk. Examples of memory devices include solid state memory and a hard disk drive. In some examples, memory includes non-transitory, computer readable memory that stores computer-readable, computer-executable software including instructions that, when executed, cause the processor unit 505 to perform various functions described herein. The memory may similarly store data used and/or generated as part of executing such instructions.

The I/O module 510 manages the flow of information between the image processing apparatus 500 and external devices. For example, the I/O module may handle communications occurring over the communication network 120 as described above.

The training component 515 is included in the image processing apparatus 500 to enable and facilitate the learning process of the model 525. The training component 515 may use learning algorithms to update the parameters of models based on computed losses. Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data. Machine learning parameters are adjusted during a training process to minimize a loss function or maximize a performance metric. The training process trains the machine learning model to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

The model 525 illustrated in FIG. 5 (as one example configuration) includes the feature extraction component 530, the deformation compensation component 535, and the similarity comparison component 540. The feature extraction component 530 may be configured to process input images (i.e., cross-section images of gaskets) and generate feature representations. In some examples, the feature extraction component 530 comprises multiple convolutional layers followed by pooling layers, designed to capture hierarchical features of the gasket profile. Feature extraction component 530 may be trained on a diverse dataset of gasket cross-sections to recognize key attributes such as overall shape, number, and arrangement of chambers, etc., and presence of specific elements indicating defects. The output of feature extraction component 530 may be a multi-dimensional feature vector that encapsulates the characteristics of the cross-section image of the gasket.

The deformation compensation component 535 may be configured to modify the feature representations produced by the feature extraction component 530, accounting for various types of gasket defects. In some examples, deformation compensation component 535 may include a set of learnable transformation matrices, each corresponding to a specific type of deformation (e.g., stretching, compression, warping, etc.). These matrices may be applied to the feature representation in a weighted manner, with the weights determined by neural networks that assesses the type and degree of deformation present in the input image. Deformation compensation component 535 may also include a feedback mechanism for iteratively refining the compensation based on the similarity scores produced by the similarity comparison component 540. The model 525 may generate a compensated or modified feature representation of the input image using the deformation compensation component 535. In some examples, additional information provided regarding the gasket captured in the inputted image may be used by the deformation compensation component 535 (e.g., to define weights).

The similarity comparison component 540 may be configured to compare the modified feature representations against a large database of reference gasket profiles. For example, similarity comparison component 540 may employ a hierarchical similarity computation structure, starting with a coarse-grained comparison to quickly filter out dissimilar candidates, followed by progressively finer-grained comparisons on the remaining subset. The similarity comparison component 540 may rank the potential matches based on similarity scores and confidence levels and presents top recommendations to the user. For example, the top recommendations may include a replacement gasket selected based on a corresponding reference representation that has the highest similarity with the feature representation.

It should be understood that, in some examples, the gasket profiles may include gaskets in various deformed states, which may be virtually altered as described above. In this configuration, the deformation compensation component 535 may not be needed as the generated feature representation can be compared with the profiles to find a matching gasket. Alternatively or additionally, in some examples, the deformation compensation component 535 may be used to modify a feature representation to account for tears, rips, or other defects that may be difficult to effectively account for in the profiles. Accordingly, in this example, regardless of whether the model has access to gasket profiles for normal gaskets and/or deformed gaskets, the deformation compensation component 535 may be used modify the feature representation to account for some types of detects to improve the accuracy of the classification performed via the model.

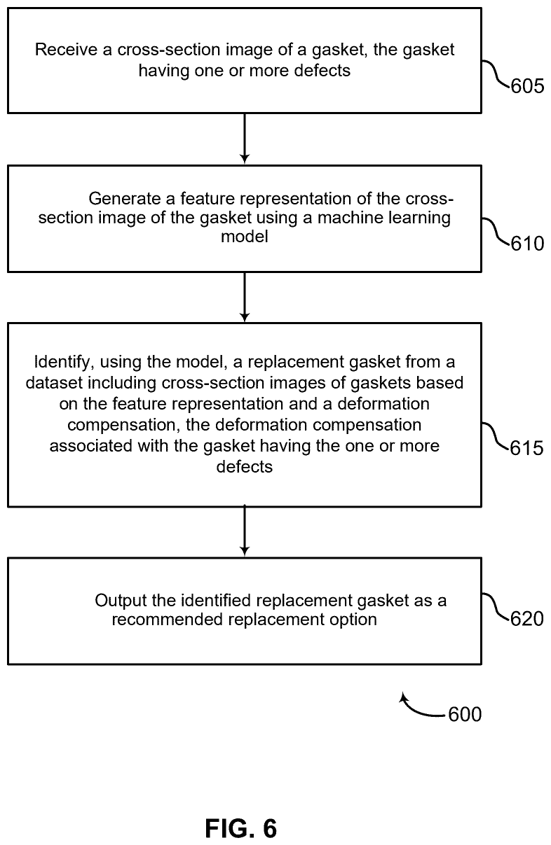

FIG. 6 shows a computer-implemented processing method 600 using the model 525 as described above. At operation 605, the system (the image processing apparatus 115/500 as described above and associated system components) receives a cross-section image of a gasket, the gasket having one or more defects. As noted above, in some examples, the cross-section image is a visual representation of the gasket's profile. For example, the visual representation may be a two-dimensional image of the gasket. The visual representation may demonstrate the gasket's internal structure and shape.

In some examples, the visual representation captures the current state of the gasket including defects such as wear, deformation, or damage. For example, as described above with respect to FIGS. 2 and 3, these defects may include stretching, compression, tears, or other forms of deformations or degradation that may affect the gasket's shape and associated functionality.

At operation 610, the system generates a feature representation of the cross-section image of the gasket using the model 525. In some examples, the system processes the input image to extract meaningful features that characterize the gasket's profile. The model may include a convolutional neural network (CNN). The CNN analyzes the image to identify key attributes of the gasket's cross-section. These features may include the overall shape, the number and arrangement of chambers, the presence of ridges or other strips, and other distinctive elements.

In some examples, operation 610 may involve feature detection using keypoints. Keypoints may refer to points in an image that are distinctive, such as corners and edges, and are invariant to changes in scale and rotation. The system may use feature detection and description algorithms in the model 525 to detect and compute a description for each keypoint. For example, a description of a keypoint may be a vector that encodes information about a local image region around the keypoint.

As noted above, in some examples, the deformation compensation associated with the gasket can applied to the generated feature representation to account for the defects in the imaged gasket. As noted above, in some examples, the system considers a deformation compensation to account for the defects represented in the feature representation. By applying this compensation, the system may virtually restore a representation of the cross-section image of the gasket without the defects, allowing for more accurate comparison with the gasket profiles in the database (e.g., where the gasket profiles are associated with gasket without defects).

In some examples, at operation 615, the system compares the feature representation generated in operation 610 (and optionally modified via the deformation compensation component) to a database of gasket profiles. In some examples, the database includes a plurality of gasket profiles, which may include cross-section images of gaskets without defects, one or more feature representations based on the same and generated by the model 525, or a combination thereof and associated metadata indicate a unique identifier of the gasket represented via the gasket profile. In some embodiments, the system compares the feature presentation generated in operation 610 to the gasket profiles to identify a closest match, where various comparison or distance metrics, such as, for example, a Euclidean distance, may be used to identify such matches.

In some examples, operation 615 may incorporate additional information provided by the user. The additional information may include details about the appliance in which the gasket is used, such as the type of appliance (e.g., refrigerator, freezer, dishwasher), the manufacturer, model, or size. The system may use this information to further refine its search and optionally ensure that the identified replacement gasket is not only similar in profile but also compatible with the specific appliance. For example, the system may use the additional information to confirm or validate identified matches, such as by ensuring that the matching gasket is approved (or recommended) for use with particular types of appliances, brands of appliances, operating conditions, etc. as defined by the additional information.

At operation 620, the system outputs a replacement recommendation based on the identified matching gasket. As noted above, the recommendation may include an image of the gasket (e.g., a cross-sectional image or a perspective view), specifications of the gasket, availability of the gasket, etc., and may be presented within a GUI provided on the image capture device 110. Alternatively or in addition, the recommendation may be communicated as an email message, a SMS message, or the like. In some examples, a plurality of recommendations may be provided and may be ranked based on a degree of similarity, an availability, a match based on the additional information, etc. The number and filtering of such recommendations may be configurable such that a user can select to see a predetermined number of matches and/or matches filtered in a particular manner (e.g., according to a particular filtering characteristic).

In some examples, rather than comparing feature representations, the model 525 may be a model configured to use a feature representation of an inputted image to classify an image. For example, using supervised training applied via the training component, the model 525 may be trained to classify an image based on the generated feature representation (as optionally modified to account for defects as described above) without the need to compare the feature representation to a stored feature representation for a particular gasket. To train the model 525 to perform this functionality, references images (which may include images of normal gaskets, deformed gaskets, or a combination therefore) are input to the model along with ground truth labels, which the model 525 uses to learn patterns of feature representations associated with a particular gasket.

Also, in some examples, the model 525 may be configured, through supervised learning, to learn how to modify the feature representation to account for defects (i.e., modified the feature representation to best match a feature representation of the gasket without defects).

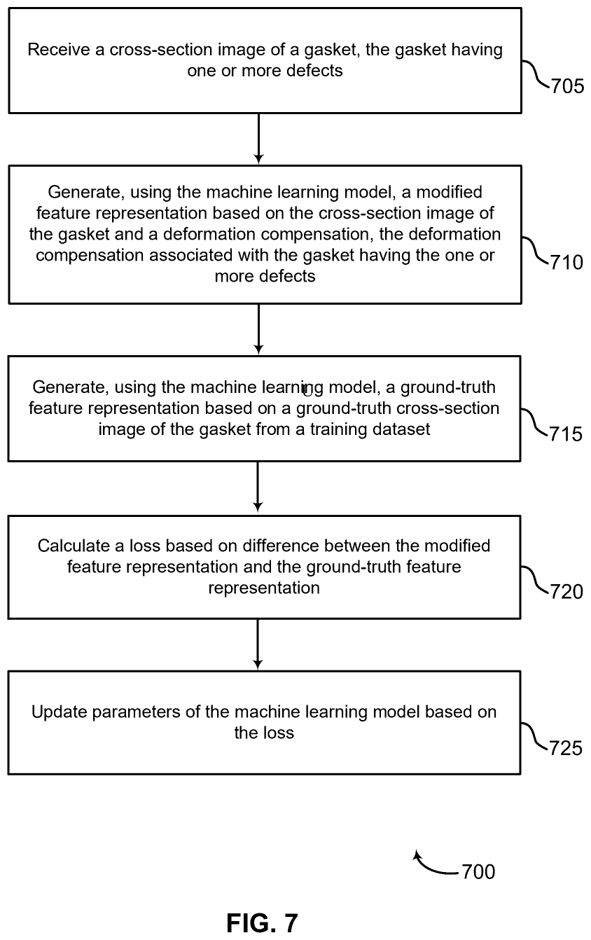

For example, FIG. 7 shows a computer-implemented training method 700 for training such a machine learning model. A system trained using the computer-implemented training method 700 may be the image processing apparatus 115/500 as described above and associated system components. The training process be repeated multiple times with various gasket images, showing different types and degrees of defects. This variety helps the model learn to generalize across a wide range of gasket conditions.

At operation 705, the system receives a training dataset. The training dataset includes a cross-section image of a gasket, the gasket having one or more defects. The training dataset also includes a cross-section image of the same gasket without defects (representing a ground-truth image).

At operation 710, the system generates, using the machine learning model, a modified feature representation based on the cross-section image of the gasket with defects and a deformation compensation, the deformation compensation associated with the gasket having the one or more defects.

For example, at operation 710, the machine learning model processes the input image of the gasket with defects to create a feature representation. The machine learning model also applies deformation compensation to this representation. By using the deformation compensation, the machine learning model learns to virtually restore the effects of the defects, thus generating a compensated or modified feature representation that represent the gasket's original, undamaged profile. The machine learning model may thus learn to match worn gaskets to the corresponding replacements in real-world applications.

At operation 715, the system generates, using the machine learning model, a ground-truth feature representation based on the ground-truth cross-section image of the gasket from the training dataset. The ground truth cross-section image may represent a version of the gasket without defects. By processing the ground-truth image, the model creates a feature representation of what the gasket looks like without defects.

At operation 720, the system calculates a loss based on difference between the modified feature representation and the ground-truth feature representation. For example, the loss quantifies how well the model's deformation compensation is working by measuring the difference between the modified representation and the ground-truth representation. For example, a smaller difference between the compensated feature and a reference feature representation indicates the reference feature representation is from a gasket that is closer to the gasket without defects.

At operation 725, the system updates parameters of the machine learning model based on the loss. For example, through a process like backpropagation, the model's parameters are adjusted to minimize the loss.

After the model is trained, the model can be used during interference to process inputted images (e.g., cross-section images of gaskets needing replacement) to identify recommended replacement options for the gaskets. Such inputted images can be referred to as “inference images.” For example, after training, an inference image can be inputted into the machine learning model as trained, wherein the machine learning model as trained outputs a modified representation of the inference image, and a replacement gasket for a gasket represented in the inference image can be identified based on the modified representation of the inference image. For example, as described above, wherein the modified representation of the inference image may include a modified version of a feature representation extracted from the inference image and this modified version of the feature representation can be compared the modified version of the feature representation to a set of reference feature representations to identifying one (or more) reference feature representations from the set of reference feature representations having a highest degree of similarity with the modified version of the feature representation. For example, as noted above, in some examples, a predetermined number of “matching” representations (representing potential replacements) can be identified and presented as a response to the inputted inference image. Alternatively or in addition, a degree of similarity for each reference feature representation may be compared to a threshold to identify whether the gasket associated with the reference feature representation is a potential replacement. As also noted above, the filtering and/or ranking of potential replacements can be configurable and, in some examples, may take the additional information into account (e.g., by eliminating matches that may not satisfy specifications of the appliance the gasket was used with). Such filtering may also be performed as part of the comparison step to limit the number of reference feature representations that are compared to the modified version of the feature representation of the inference image.

In examples incorporating machine learning, the model may be initially trained (e.g., as described with respect to FIG. 7) but may also continue to learn during inference. =For example, feedback on replacement options provided by the system 100 may be fed into the model as further training data. Such feedback may be directed feedback, such as, for example, feedback from a user indicating whether a particular replacement option was successfully used or not. Alternatively or in addition, such feedback may also be indirect. For example, returns of ordered replacement gaskets may be tracked to determine whether a recommended replacement option was returned after purchase, which may indicate that the option was not accurate. Training may also be repeated as new gasket models are available.

In some examples, the methods and systems described herein can process images of both generic and original equipment manufacturer (OEM) gaskets. For example, generic gaskets may not be an exact replica of an OEM gasket but may act as proper replacements for the same. The systems and methods described herein may use references images and/or training images capturing both generic and OEM versions of gasket, which allows the systems and methods to identify an OEM version from an image of a generic gasket or vice versa. For example, reference or training images for a particular gasket may include both generic version(s) of the gasket and OEM version(s) of the gasket to allow the systems to properly match an inputted image to the proper gasket regardless of whether the image represents a generic or OEM gasket.

In addition or alternatively, the systems and methods may be configurable (e.g., by an administrator or other user) to allow for variances between identified “matches” to properly handle generic and OEM versions of gasket. For example, a user may be able to establish (or the systems and methods may learn from feedback to identified matches) an acceptable level of difference between “matches” to account for both generic and OEM versions of gasket. Also, in some examples, the systems and methods more store one or more rules for mapping one version to a gasket to another version. For example, in response to identifying a match to an inputted image that includes a generic version of a gasket, the systems and methods may apply one or more rules to identify the corresponding OEM version. One or both of the identified versions may be provided as matches or the type of the match (e.g., generic versus OEM) may impact a ranking of the matching within a provided list of potential matches.

Therefore, examples described herein identify a gasket represented within a captured image and accounts for defects in the gasket. As described herein, this identification can be performed using image comparison and matching techniques, feature representations extracted from images and corresponding comparisons, machine learning, or a combination thereof. For example, a machine learning model may be trained to modify an inputted image of a gasket to account for defects and, in other words, transform the image, or a feature representation) to closely represent an image or feature representation of the same gasket without the defects. This modified object can then be used to identify a matching gasket, which can be provided as a replacement recommendation option. The methods and systems described herein address technological problems with existing gasket identification techniques by account for defects and also, optionally, using additional information to improve the speed and accuracy of identified matches.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

What is claimed is:

1. An apparatus comprising:
at least one electronic processor; and
at least one memory storing instructions executable by the at least one electronic processor, the at least one electronic processor configured, through execution of the instructions, to:
receive a cross-section image of a gasket, the gasket having one or more defects;
generate one or more modified representations of the gasket represented in the cross-section image, the one or more modified representations of the gasket representing the gasket without the one or more defects; and
identify, based on the one or more modified representations of the gasket, a replacement gasket.

2. The apparatus of claim 1, wherein the one or more modified representations include one or more virtually altered versions of the cross-section image of the gasket and wherein the at least one electronic processor is configured to identify the replacement gasket by comparing the one or more virtually altered versions of the cross-section image with a set of reference images of gaskets to identify a matching reference image, the matching reference image representing the replacement gasket.

3. The apparatus of claim 1, wherein the one or more modified representations include a modified version of a feature representation extracted from the cross-section image of the gasket and wherein the at least one electronic processor is configured to identify the replacement gasket by comparing the modified version of the feature representation to feature representations extracted from a set of reference images of images to identify a matching feature representation.

4. The apparatus of claim 1, wherein the one or more modified representations include a modified version of a feature representation extracted from the cross-section image of the gasket and wherein the at least one electronic processor is configured to identify the replacement gasket by classifying the cross-section image based on the modified version of the feature representation.

5. The apparatus of claim 1, wherein the one or more modified representations include a feature representation extracted from the cross-section image of the gasket modified based on a deformation compensation and wherein the at least one electronic processor is configured to generate the deformation compensation using a machine learning model, the machine learning model trained to determine the deformation compensation using a training data set including a plurality of cross-section images of a plurality of gaskets with one or more defects and a plurality of ground-truth image of the plurality of gaskets without defects.

6. The apparatus of claim 5, wherein the deformation compensation is based on additional information about the gasket.

7. The apparatus of claim 1, wherein the at least one electronic processor is further configured to receive additional information associated with the cross-section image of the gasket, wherein the additional information includes at least one selected from a group consisting of a type of appliance the gasket was used with, a model of the appliance the gasket was used with, an age of the appliance, and an age of the gasket.

8. The apparatus of claim 7, wherein the at least one electronic processor is configured to filter a set of reference images of gaskets based on the additional information, wherein the electronic processor is configured to identify the replacement gasket by comparing the cross-section image of the gasket to the filtered set of reference images.

9. The apparatus of claim 7, wherein the at least one electronic processor is configured to identify the replacement gasket by filtering, using the additional information, a plurality of matching gaskets identified based on the cross-section image of the gasket.

10. The apparatus of claim 7, wherein the at least one electronic processor is further configured to validate the replacement gasket using the additional information.

11. A computer-implemented method comprising:
receiving a cross-section image of a gasket, the gasket having one or more defects;
generating, a feature representation of the cross-section image of the gasket using a machine learning model; and
identifying, using the machine learning model, a replacement gasket from a dataset including gasket profiles and a deformation compensation.

12. The method of claim 11, where identifying the replacement gasket comprises:
modifying the feature representation using the deformation compensation to obtain a modified feature representation;
generating reference feature representations based on cross-section images of gaskets in the gasket profiles using the machine learning model; and
identifying the replacement gasket based on a similarity between the feature representation and each reference feature representation, the replacement gasket associated with a reference representation having a highest similarity with the feature representation.

13. The method of claim 11, further comprising:
providing, via one or more graphical user interfaces, a prompt; and
receiving, via the one or more graphical user interfaces, additional information about an appliance the gasket was used with, wherein
identifying the replacement gasket includes identifying the replacement gasket based on the feature representation, the deformation compensation, and the additional information.

14. The method of claim 11, wherein the machine learning model includes a convolutional neural network (CNN) trained on cross-section images of gaskets to identify cross-section features.

15. A computer-implemented method for training a machine learning model, the method comprising:
receiving a training dataset, the training dataset including cross-section image of a gasket having one or more defects, and a ground truth cross-section image of the gasket without defects;
generating, using the machine learning model, a modified feature representation based on the cross-section image of the gasket and a deformation compensation;
generating, using the machine learning model, a ground-truth feature representation based on the ground-truth cross-section image of the gasket from the training dataset;
calculating a loss based on difference between the modified feature representation and the ground-truth feature representation; and
updating parameters of the machine learning model based on the loss.

16. The computer-implemented method of claim 15, wherein the modified feature representation is generated based on the cross-section image of the gasket, the deformation compensation, and additional information including information regarding an appliance the gasket is used with.

17. The computer-implemented method of claim 16, wherein the information regarding the appliance includes at least one of an appliance type, an appliance manufacturer, an appliance model, and an appliance size.

18. The computer-implemented method of claim 15, the method further comprising:
inputting into the machine learning model as trained an inference image, wherein the machine learning model as trained outputs a modified representation of the inference image, and
identifying a replacement gasket for a gasket represented in the inference image based on the modified representation of the inference image.

19. The computer-implemented method of claim 18, wherein the modified representation of the inference image includes a modified version of a feature representation extracted from the inference image.

20. The computer-implemented method of claim 19, wherein identifying the replacement gasket includes comparing the modified version of the feature representation to a set of reference feature representations and identifying one reference feature representation from the set of reference feature representations having a highest degree of similarity with the modified version of the feature representation.
